(19) United States
(12) Patent Application Publication
(10) Pub. No.: US 2013/0202951 A1
(43) Pub. Date: Aug. 8, 2013

(54) ELECTROCHEMICAL DEVICE

(71) Applicants: Yuki Kawai, Tokyo (JP); Kyotaro Goto, Tokyo (JP)

(72) Inventors: Yuki Kawai, Tokyo (JP); Kyotaro Goto, Tokyo (JP)

(21) Appl. No.: 13/810,889

(22) PCT Filed: Jun. 24, 2011
(86) PCT No.: PCT/JP2011/064505

§ 371 Date: Mar. 29, 2013

(30) Foreign Application Priority Data
Jul. 22, 2010 (JP) 2010 164713

(51) Int. Cl. H01G 11/02; H01G 11/04; H01G 11/06; H01M 2/04

(52) U.S. Cl. CPC H01G 11/02; H01M 2/0486; H01G 11/04; H01G 11/06
USPC 429/178; 361/502; 361/517

(57) ABSTRACT

An electrochemical device which is free from deterioration of properties due to a process of joining a rigid case and a conductive lid is provided. A welded part PP of a conductive lid 12 and a welded frame member 11d are joined each other by laser welding. A weld bead for joining the welded part PP and the welded frame member 11d is not exposed to an internal space of a rigid package 10; therefore, fused material, the coagulum thereof, or the like created during laser welding are prevented from entering into the internal space of the rigid package 10.

### TECHNICAL FIELD

The present invention relates to an electrochemical device having a structure in which a storage element and electrolytic solution is enclosed with a rigid package composed of a metal, a ceramics or the like, and being capable of surface mounting on a circuit board or the like.

### BACKGROUND

This type of electrochemical device generally includes a substantially rectangular and parallelepiped-shaped rigid package, a storage element and electrolytic solution enclosed in the internal space of the rigid package, and a negative and positive electrode terminals each formed on the flat bottom face of the rigid package. The rigid package includes a rigid case having a cavity providing an upward opening and a conductive lid configured to seal the opening of the cavity in a watertight and airtight manner. The storage element is configured by stacking a positive electrode plate and a negative electrode plate with a separate sheet therebetween. Such a rigid case has a wire for electrically connecting the negative electrode plate of the storage element to the negative electrode terminal via the conductive lid, and another wire for electrically connecting the positive electrode plate of the storage element to the positive electrode terminal.

Such an electrochemical device is known through, for example, Japanese Patent Application Publication No. 2009-278068 (the “Patent Literature 1”) and Japanese Patent Application Publication No. 2006-049289 (the “Patent Literature 2”) where a rigid case of an electrochemical device is joined with a conductive lid.

The Patent Literature 1 discloses an electrochemical device wherein (1) a multi-layered film composed of Cr, Pd, Ni, Cu or other materials is formed on the top face of a case, the case being composed of soda-lime glass or crystallized glass so as to surround a cavity; (2) a plating film is formed on the top face of the multi-layered film, the plating film being composed of Cu, Ni, or Au; (3) a metal ring is brazed to the top face of the plating film using a wax material composed of an Ag—Cu alloy or an Ag—Cu—Sn alloy, the metal ring being composed of a Fe—Ni alloy or a Fe—Ni—Co alloy; (4) a metal coating is formed on the top face of the metal ring, the metal coating being composed of Ni and Au; and (5) a tabular conductive lid is joined to the top face of the metal ring by seam welding, the tabular conductive lid being composed of a Fe—Ni alloy or a Fe—Ni—Co alloy.

The Patent Literature 2 discloses an electrochemical device wherein (1) a tungsten layer is formed on the top face of a case composed of an alumina sintered body so as to surround a cavity, and a Ni layer is formed on the surface of the tungsten layer; (2) a frame-shaped member composed of a Fe—Ni—Co alloy, Al, or a Fe—Ni—Co alloy having an Al layer formed on a surface thereof, is brazed on the top face of the Ni layer with an Ag wax or an Al wax; (3) a tabular conductive lid composed of a Fe—Ni—Co alloy, an Al alloy, or a Fe—Ni—Co alloy having Al joined to the bottom face thereof by cladding, is joined to the top face of the frame-shaped member by seam welding.

The Patent Literatures 1 and 2 employ seam welding to join the rigid case and the conductive lid. The seam welding is a technique that achieves desired joining by pressurizing welding objects (the conductive lid and the metal ring in the Patent Literature 1, the conductive lid and the frame-shaped member in the Patent Literature 2) together by a roller electrode; applying electricity through the welding objects, while rotating the roller electrode; and fusing together the welding objects by resistance heating caused by the applied electricity.

Since the seam welding fuses together the welding objects by resistance heating caused by the applied electricity, if the welding objects contact each other on surfaces thereof, the whole area of the contact surfaces is a welding area. In the Patent Literature 1 and 2 where the rigid case and the conductive lid are joined, since an inside edge of a contact surface of each of the welding objects is exposed to an internal space in the rigid package, a fused material, coagulum thereof, or the like created during seam welding enters the internal space in the rigid package, and then mixes into an electrolytic solution or adheres to the storage element. Consequently this may cause deterioration of properties.

In addition, paragraphs [0139]-[0144] in the Patent Literature 1 disclose that laser welding can be employed instead of seam welding. However, the structure of such an electrochemical device is the same as an electrochemical device employing seam welding and there is no description of a structure, method or the like specific to laser welding.

### RELEVANT REFERENCES

### Patent literature

Patent Literature 1: Japanese Patent Application Publication No. 2009-278068

Patent Literature 2: Japanese Patent Application Publication No. 2006-049289

### SUMMARY

Embodiments of the present invention provide an electrochemical device which is free from deterioration of properties due to joining a rigid case and a conductive lid.

An electrochemical device according to one embodiment of the present invention includes: a rigid package; a storage element and an electrolytic solution enclosed in an internal space of the rigid package; and a negative electrode terminal and a positive electrode terminal formed on the bottom face of the rigid package, wherein the rigid package includes a rigid case having a cavity providing an upward opening and a conductive lid sealing the upward opening of the cavity in a watertight and airtight manner, the rigid case including a first wire for electrically connecting a negative electrode plate of the storage element to the negative electrode terminal via the conductive lid and a second wire for electrically connecting a positive electrode plate of the storage element to the positive electrode terminal. In one embodiment of the present invention, a welded frame member having a predetermined width is formed integrally on the top of the rigid case so as to surround the cavity, and the welded part and the welded frame member are joined to each other by laser welding such that a weld bead formed by laser welding at the welded part and the welded frame member is not exposed to the internal space of the rigid package.

The electrochemical device according to one embodiment of the present invention can prevent a fused material, coagulum thereof, or the like created during laser welding from entering the internal space of the rigid package, because the weld bead is not exposed to the internal space of the rigid package. Accordingly, the electrochemical device according to one embodiment of the present invention can prevent deterioration of properties resulting when a fused material, coagulum thereof, or the like created during laser welding mixes into an electrolytic solution or adheres to the storage element.

Embodiments of the present invention can provide an electrochemical device which is free from deterioration of properties due to joining a rigid case and a conductive lid.

Other purposes, configurations, features, and effects of the invention will be apparent through the following descriptions and the attached drawings.

### BRIEF DESCRIPTION OF THE DRAWINGS

FIG. 1A is a top view of an electrochemical device according to one embodiment of the present invention.

FIG. 1B is a bottom view of the same.

FIG. 2 is an enlarged cross-sectional view of the electrochemical device of FIG. 1A taken along S1-S1 line.

FIG. 3 is a top view of a first sheet composing a rigid case.

FIG. 4 is a top view of a second sheet composing the rigid case.

FIG. 5 is a top view of a third sheet composing the rigid case.

FIG. 6 is a top view of a temporary rigid case made by stacking a first sheet, a second sheet and a third sheet and firing those sheets.

FIG. 7 illustrates a process for forming a welded frame member on the temporary rigid case.

FIG. 8 illustrates a process for forming the welded frame member on the temporary rigid case.

FIG. 9 illustrates a process for forming a power collection film on the temporary rigid case.

FIG. 10 illustrates a process for forming a negative electrode terminal on the temporary rigid case.

FIG. 11 illustrates a process for forming a positive electrode terminal on the temporary rigid case.

FIG. 12 is a partial enlarged cross-sectional view of a conductive lid.

FIG. 13 illustrates a process for manufacturing the electrochemical device.

FIG. 14 illustrates a process for manufacturing the electrochemical device.

FIG. 15 illustrates a process for manufacturing the electrochemical device.

FIG. 16 illustrates a process for manufacturing the electrochemical device.

### DESCRIPTION OF EXAMPLE EMBODIMENTS

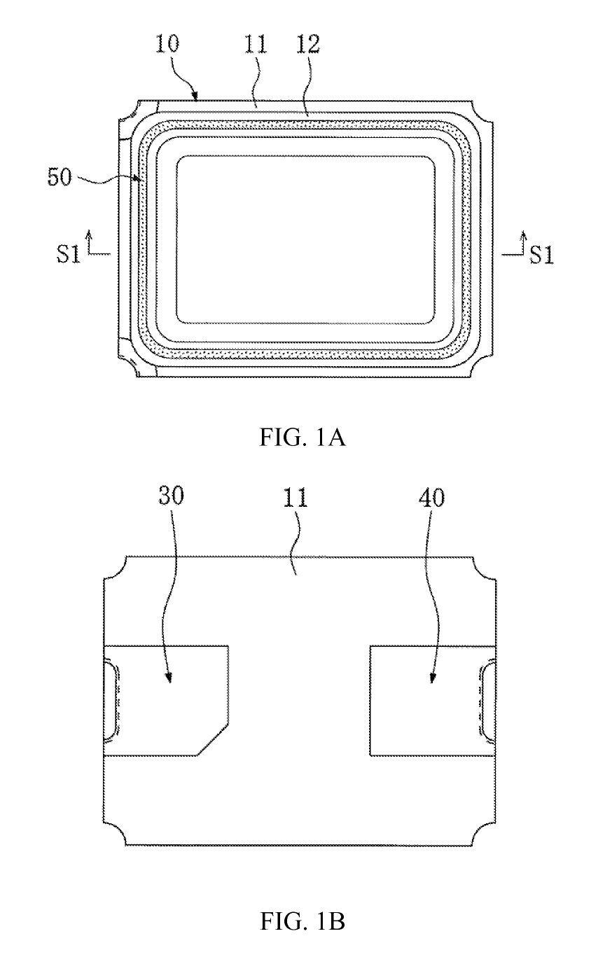

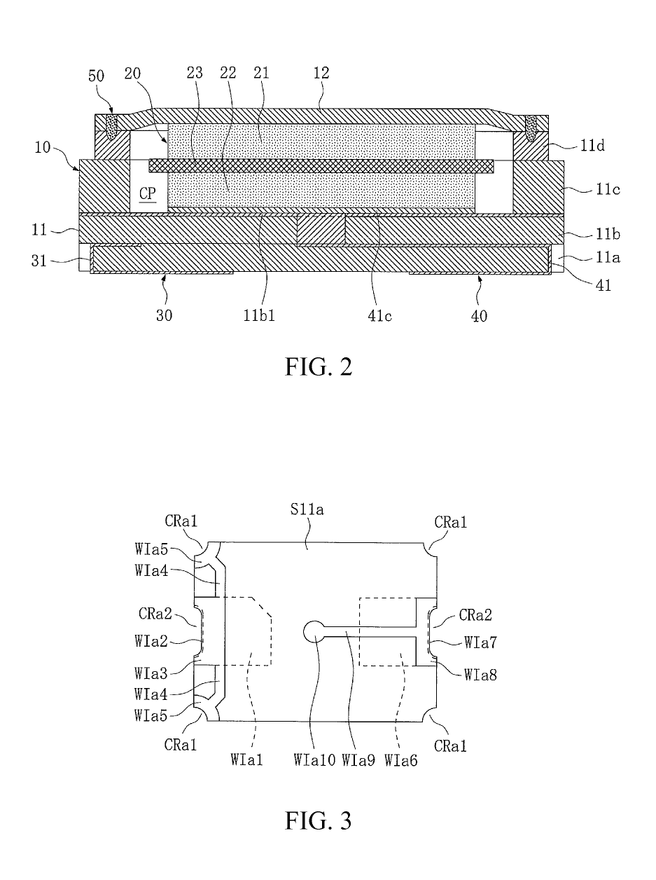

As shown in FIG. 1A, FIG. 1B, and FIG. 2, an electrochemical device according to one embodiment of the present invention includes a substantially rectangular and parallelepiped-shaped rigid package 10, a storage element 20 and electrolytic solution (not shown) enclosed in an internal space of the rigid package 10, and a negative electrode terminal 30 and positive electrode terminal 40 formed on the flat bottom face of the rigid package 10.

The rigid package 10 includes a rigid case 11 having a cavity CP providing an upward opening and a conductive lid 12 sealing the opening of the cavity CP in a watertight and airtight manner. The rigid case 11 has a first wire 31 for electrically connecting a negative electrode plate 21 of the storage element 20 to the negative electrode terminal 30 via the conductive lid 12, and a second wire 41 for electrically connecting a positive electrode plate 22 of the storage element 20 to the positive electrode terminal 40.

Hereinafter, a structure of the rigid case 11 and a method for manufacturing the same will be described. As shown in FIG. 2, the rigid case 11 integrally has a substantially rectangular and board-shaped first layer 11a, a substantially rectangular and board-shaped second layer 11b located on the first layer 11a, a substantially rectangular and frame-shaped third layer 11c located on the second layer 11b, and a substantially rectangular and frame-shaped welded frame member 11d located on the third layer 11c.

First, in order to manufacture the rigid case 11, a first sheet S11a, a second sheet S11b, and a third sheet S11c are prepared.

FIG. 3 illustrates a top view of the first sheet S11a. The first sheet S11a is manufactured by forming unfired W (tungsten) films WIa1-WIa10 using a technique such as screen printing or the like on a substantially rectangular-shaped green sheet composed mainly of Al₂O₃. As illustrated, notches CRa1 are formed at each of four corners of the green sheet. In addition, notches CRa2 are formed at each of a pair of shorter sides of the green sheet. The W film WIa2 is formed on an inner surface of one of the notches CRa2 and the W film WIa7 is formed on an inner surface of the other of the notches CRa2. In this specification, the “inner surface” of a notch refers to the surface which connects the bottom face and the top face of the green sheet and demarcates the notch. For example, the inner surface of the notch CRa2 refers to the surface which connects the bottom face and the top face of the green sheet where the notch is formed and demarcates the notch CRa2.

The substantially rectangular-shaped W film WIa1 is formed on the bottom face of the green sheet so as to contact the left side of the green sheet. The W film WIa1 is connected to a substantially rectangular-shaped W film WIa3 formed on the top face of the green sheet via the W film WIa2. On the top face of the green sheet, the arc-shaped W films WIa5 are formed at each of edges facing respectively a pair of the notches CRa1 (inner edges of the notches CRa1) located at both ends of the left side of the green sheet. The W films WIa5 are connected to the W film WIa3 via a pair of belt-shaped W films WIa4 formed on the top face of the green sheet.

Further, the substantially rectangular-shaped W film WIa6 is formed on the bottom face of the green sheet so as to contact the right side of the green sheet. The W film WIa6 is connected to the substantially rectangular-shaped W film WIa8 formed on the top face of the green sheet via the W film WIa7 formed on the inner surface of the notch CRa2 located at the right side of the green sheet. In addition, the circular W film WIa10 is formed near the center of the top face of the green sheet. The W film WIa10 is connected to the W film WIa8 via the belt-shaped W film WIa9.

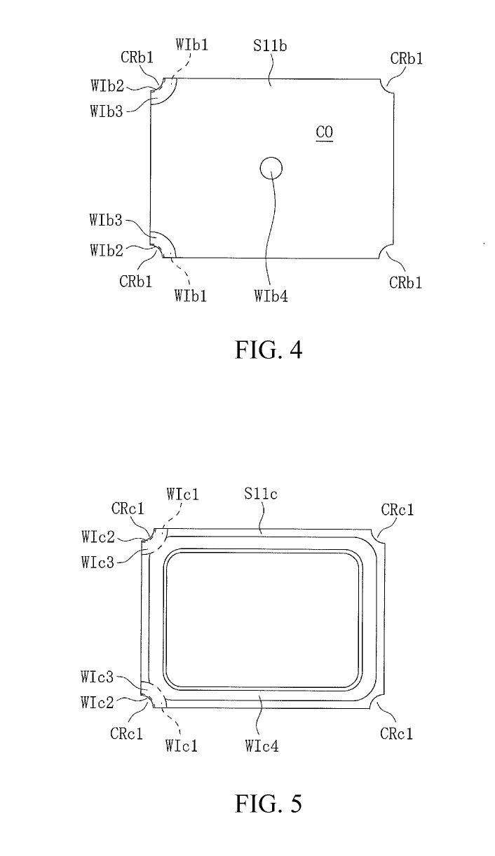

FIG. 4 illustrates a top view of the second sheet S11b. The second sheet S11b is manufactured by forming unfired W (tungsten) films WIb1-WIb4 using a technique such as screen printing or the like on a substantially rectangular-shaped green sheet composed mainly of Al₂O₃, and forming an unfired dielectric film CO composed mainly of Al₂O₃ using a technique such as coating or the like. As illustrated, notches CRb1 are formed at each of four corners of the green sheet. On the bottom face of the green sheet, the arc-shaped W films WIb1 are formed at each of edges facing respectively a pair of the notches CRb1 located at both ends of the left side of the green sheet. A pair of W films WIb1 is formed at the locations respectively corresponding to the locations of a pair of the W films WIa5 on the first sheet S11a. On the top face of the green sheet, the arc-shaped W films WIb3 are formed at each of edges facing respectively a pair of the notches CRb1 located at both ends of the left side of the green sheet. The W film WIb1 and the W film WIb3 are connected to each other via the W film WIb2 formed on an inner surface of the notch CRb1.

The columnar W film WIb4 penetrating the green sheet in the direction of the thickness thereof is formed at the center of the green sheet. The W film WIb4 is formed at the location corresponding to the location of the circular W film WIa10 on the first sheet S11a, and the diameter of the W film WIb4 is substantially the same as the diameter of the W film WIa10. In addition, the dielectric film CO is formed on the top face of the green sheet so as not to cover the W films WIb3 and the W film WIb4. That is, the dielectric film CO is formed on the substantially whole area of the top face of the green sheet excluding the area where the W films WIb3 and the W film WIb4 are formed.

FIG. 5 illustrates a top view of the third sheet S11c. The third sheet S11c is manufactured by forming unfired W (tungsten) films WIc1-WIc4 using a technique such as screen printing or the like on a substantially rectangular and frame-shaped green sheet composed mainly of Al₂O₃. As illustrated, notches CRc1 are formed at each of four corners of the green sheet. On the bottom face of the green sheet, the arc-shaped W films WIc1 are formed at each of edges facing respectively a pair of the notches CRc1 located at both ends of the left side of the green sheet. A pair of the W films WIc1 is formed at the locations respectively corresponding to the locations of a pair of the W films WIb1 on the second sheet S11b. On the top face of the green sheet, the arc-shaped W films WIc3 are formed at each of edges facing respectively a pair of the notches CRc1 located at both ends of the left side of the green sheet. The W film WIc1 and the W film WIc3 are connected to each other via the W film WIc2 formed on an inner surface of the notch CRc1.

The substantially rectangular and frame-shaped W film WIc4 is further formed on the top face of the green sheet. The W film WIc4 has the width less than the width of the top face of the substantially rectangular and frame-shaped green sheet, and a part of the peripheral line thereof is connected to each of a pair of the W films WIc3.

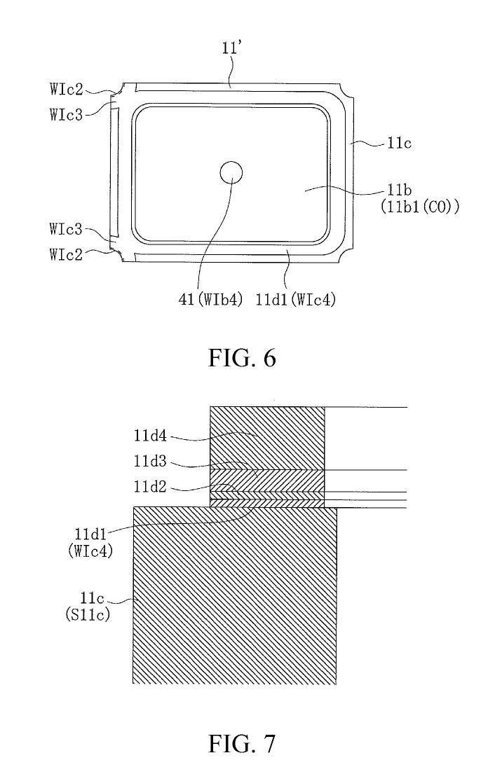

Next, a temporary rigid case 11′ shown in FIG. 6 is made by placing the second sheet S11b on the first sheet S11a prepared as described above, placing the third sheet S11c on the second sheet S11b, compressing and bonding those sheets together, subsequently placing this into a firing furnace and firing entirely. The thickness of each of the fired W films WIa1-WIa10, WIb1-WIb3 and WIc1-WIc4 is, for example, approximately 10 μm and the thickness of the fired dielectric film 11b1(CO) is, for example, approximately 5 μm.

In the temporary rigid case 11′, the fired W films WIa1, WIa2, WIa3, WIa4, WIa5, WIb1, WIb2, WIb3, WIc1, WIc2, WIc3 and WIc4 are electrically connected each other. In addition, the fired W films WIa6, WIa7, WIa8, WIa9, WIa10 and WIb4 are electrically connected each other. The fired W film WIa1 is used as a ground film 30a for the negative electrode terminal 30, the fired W film WIc4 is used as a ground film 11d1 for the substantially rectangular and frame-shaped welded frame member 11d, and the fired W film WIa6 is used as a ground film 40a for the positive electrode terminal 40.

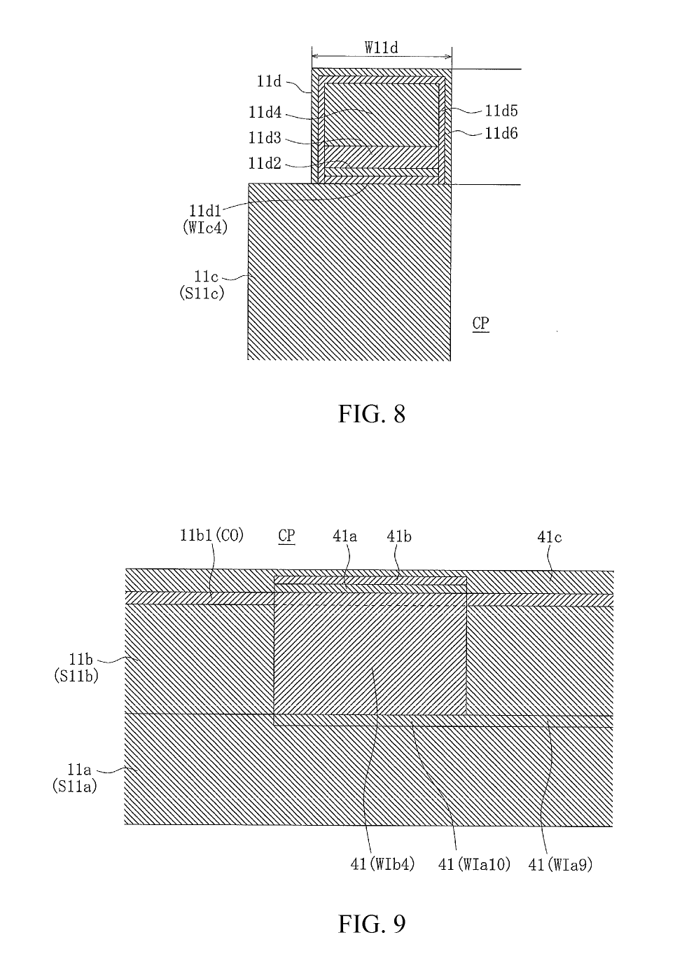

As shown in FIG. 7, a Ni film 11d2 having a thickness of approximately 4 μm is formed on a surface of the ground film 11d1 (the fired W film WIc4) of the temporary rigid case 11′ using a technique such as electroplating or the like. A base member 11d4 composed of a Fe—Ni—Co alloy (Kovar) is joined on a surface of the Ni film 11d2 with an Ag—Cu wax 11d3 having a thickness of approximately 5 μm. Next, as shown in FIG. 8, a Ni film 11d5 having a thickness of approximately 4 μm is formed using a technique such as electroplating or the like, so as to cover every surfaces of the ground film 11d1, the Ni film 11d2, the Ag—Cu wax 11d3 and the base member 11d4. In addition, an Au film 11d6 having a thickness of approximately 2 μm is formed using a technique such as electroplating or the like so as to cover a surface of the Ni film 11d5. Consequently, the welded frame member 11d composed of the ground film 11d1, the Ni film 11d2, the Ag—Cu wax 11d3, the base member 11d4, the Ni film 11d5 and the Au film 11d6 is formed. And, the welded frame member 11d is formed so as to be substantially rectangular and frame-shaped as well as the ground film 11d1.

As is evident from above description, in one embodiment, the substantially rectangular and frame-shaped welded frame member 11d formed on the top face of the rigid case 11 so as to surround the cavity CP, is configured to include the ground film 11d1, the Ni film 11d2, the Ag—Cu wax 11d3, the base member 11d4, the Ni film 11d5 and the Au film 11d6. The welded frame member 11d is formed so as to be shaped into a rectangular and frame shape having the substantially fixed width Wild of top view. A surface of the Au film 11d6 facing the cavity CP forms the upper part of an inner surface demarcating the cavity CP.

Further, as shown in FIG. 9, a Ni film 41a having a thickness of approximately 4 μm is formed using a technique such as electroplating or the like on a surface (exposed surface) of the fired W film WIb4 of the temporary rigid case 11′. In addition, an Au film 41b having a thickness of approximately 2 μm is formed using a technique such as electroplating or the like on the top face of the Ni film 41a. And, a power collection film 41c composed of Al and having a thickness of approximately 30 μm is formed using a technique such as coating, vapor deposition or the like so as to cover surfaces of the Ni film 41a and the Au film 41b and a surface of the dielectric film 11b1(CO). The size of the power collection film 41c is substantially identical to the size of the positive electrode plate 22 of the storage element 20.

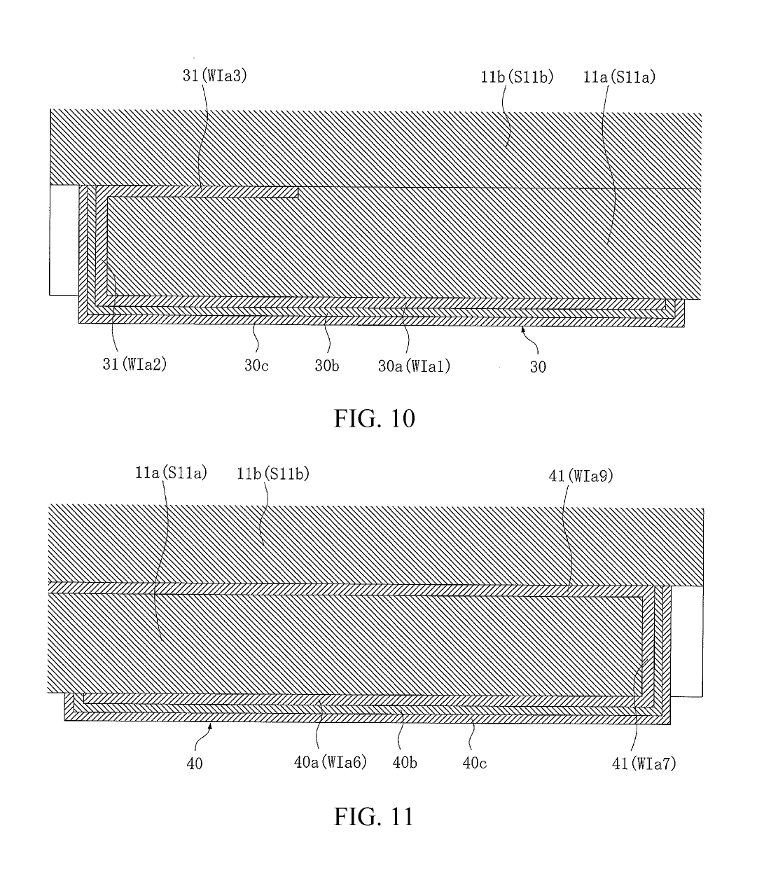

Furthermore, as shown in FIG. 10, a Ni film 30b having a thickness of approximately 4 μm is formed using a technique such as electroplating or the like so as to cover surfaces of the ground film 30a (the fired W film WIa1) of the temporary rigid case 11′ and the W film WIa2, and an Au film 30c having a thickness of approximately 2 μm is formed using a technique such as electroplating or the like so as to cover a surface of the Ni film 30b. Consequently, the negative electrode terminal 30 composed of the ground film 30a (the fired W film WIa1), the Ni film 30b and the Au film 30c is formed.

In addition, as shown in FIG. 11, a Ni film 40b having a thickness of approximately 4 μm is formed using a technique such as electroplating or the like so as to cover surfaces of the ground film 40a (the fired W film WIa6) of the temporary rigid case 11′ and the W film WIa7, and an Au film 40c having a thickness of approximately 2 μm is formed using a technique such as electroplating or the like so as to cover a surface of the Ni film 40b. Consequently, the positive electrode terminal 40 composed of the ground film 40a (the fired W film WIa6), the Ni film 40b and the Au film 40c is formed. In one embodiment, the Ni film 11d5, the Ni film 41a, the Ni film 30b and the Ni film 40b may be formed simultaneously by a common process. In addition, the Au film 11d6, the Au film 41b, the Au film 30c and the Au film 40c may be formed simultaneously by a common process.

As stated above, manufacture of the rigid case 11 is completed. In the rigid case 11, the first wire 31 is composed of the fired W films WIa2, WIa3, WIa4, WIa5, WIb1, WIb2, WIb3, WIc1, WIc2, WIc3 and the welded frame member 11d. The first wire 31 electrically connects the negative electrode plate 21 of the storage element 20 to the negative electrode terminal 30 via the conductive lid 12. In addition, the second wire 41 is composed of the fired W films WIa7, WIa8, WIa9, WIa10, WIb4, the Ni film 41a, the Au film 41b and the power collection film 41c. The second wire 41 electrically connects the positive electrode plate 22 of the storage element 20 to the positive electrode terminal 40.

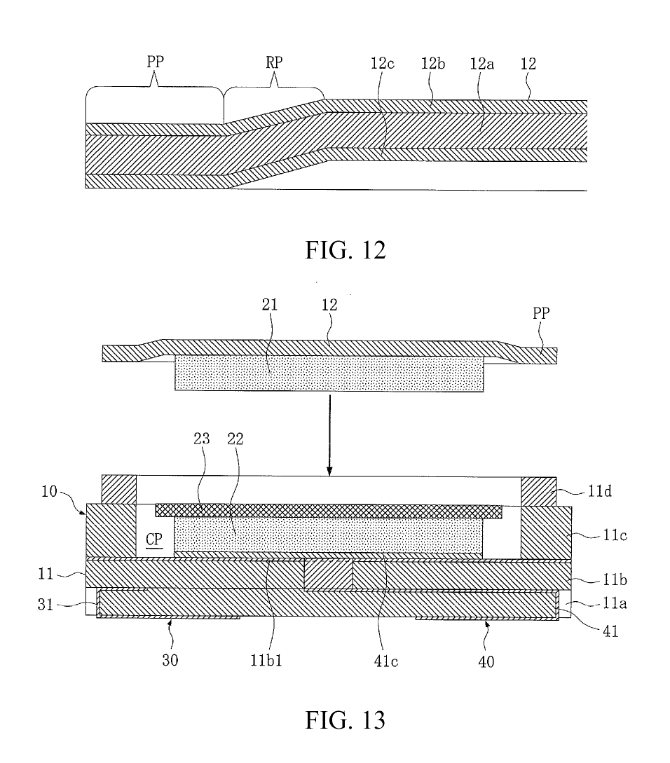

FIG. 12 illustrates a partial enlarged cross-sectional view of a conductive lid. As illustrated, the conductive lid 12 is composed of a cladding material in which a Ni layer 12b and 12c having a thickness of approximately 5 μm are formed on the top face and the bottom face of a base member 12a. The base member 12a is composed of a Fe—Ni—Co alloy (Kovar) and the thickness thereof is, for example, approximately 90 μm. Alloy layers are formed on interfaces between the base member 12a and each of the Ni layers 12b and 12c by diffusion bonding. Using a Fe—Ni—Co alloy as the base member 12a of the conductive lid 12 enables a coefficient of linear expansion of the conductive lid 12 to be identical to or close to a coefficient of linear expansion of a dielectric portion of a package made of a ceramics composed mainly of Al₂O₃. That is, if the coefficients of linear expansion of the conductive lid 12 and the dielectric portion are substantially the same, the joint between the conductive lid 12 and the dielectric portion is less likely to break, even if thermal expansion and contraction of the conductive lid and the dielectric portion occur during a process such as reflow soldering when mounting the electrochemical device on a surface of a circuit board or the like.

In addition, as shown in FIG. 12, the conductive lid 12 has a flat and ring-shaped welded part PP facing the top face of the welded frame member 11d, a ring-shaped reinforcement part RP extending from an internal circumference line of the welded part PP toward the center at an angle, and a flat part (not denoted by a reference number) located inside of the reinforcement part RP. An outline of top view of the conductive lid 12 is substantially identical to an outline of top view of a peripheral line of the welded frame member 11d of the rigid case 11. As stated above, the conductive lid 12 is not tabular but shaped such that a flat part located at the inside of the reinforcement part RP projects higher than the welded part PP of a periphery. The reinforcement part RP makes the joint between the welded part PP and the welded frame member 11d less likely to break. In one embodiment, an angle of inclination of the reinforcement part RP to the bottom face of the welded part PP is, for example, 5-30 degrees.

As shown in FIG. 2, the storage element 20 is composed of the rectangular-shaped negative electrode plate 21 having a thickness of approximately 200 μm, the rectangular-shaped positive electrode plate 22 having a thickness of approximately 250 μm, and a rectangular-shaped separate sheet 23 having a thickness of approximately 100 μm and interposed between the negative electrode plate 21 and the positive electrode plate 22. These values of thickness are only illustrative, thus the thicknesses of the negative electrode plate 21, the positive electrode plate 22, and the separate sheet 23 can be modified as appropriate in accordance with the use.

The negative electrode plate 21 and the positive electrode plate 22 are composed of active material such as activated carbon, PAS (Polyacenic Semiconductor) or the like, and the separate sheet 23 is composed of an ionic permeation sheet such as a glass sheet, a cellulose sheet, a plastic sheet, or the like. Outlines of top view of the negative electrode plate 21 and the positive electrode plate 22 are substantially identical to each other. On the other hand, an outline of top view of the separate sheet 23 is larger than the outlines of top view of the negative electrode plate 21 and the positive electrode plate 22.

A description will be given of a method for manufacturing an electrochemical device according to one embodiment of the present invention, referring to FIG. 13-FIG. 16. First, as shown in FIG. 13, the top face of the negative electrode plate 21 of the storage element 20 is pasted to the center of the bottom face of the Ni layer 12c underlying the conductive lid 12 (the center of the bottom face of the flat part located inside the reinforcement part RP) with a conductive adhesive (not shown) such as a graphite paste, and the negative electrode plate 21 pasted to the conductive lid 12 is dried under a reduced pressure at 250° C. or higher for 10 hours. Next, the negative electrode plate 21 is subjected to and impregnated with an electrolytic solution or the like.

In addition, as shown in FIG. 13, the positive electrode plate 22 of the storage element 20 is inserted in the cavity CP of the rigid case 11, the bottom face of the positive electrode plate 22 is pasted to the top face of the power collection film 41c with a conductive adhesive such as a graphite paste, and the positive electrode plate 22 pasted to the power collection film 41c is dried under a reduced pressure at 250° C. or higher for 10 hours. Next, the positive electrode plate 22 is subjected to and impregnated with the same electrolytic solution as that described above, and the separate sheet 23 is placed on the top face of the positive electrode plate 22. In one embodiment, the electrolytic solution with which the negative electrode plate 21 and the positive electrode plate 22 are impregnated is, for example, propylene carbonate (solvent) to which triethyl methyl ammonium tetrafluoroborate (solute) is added.

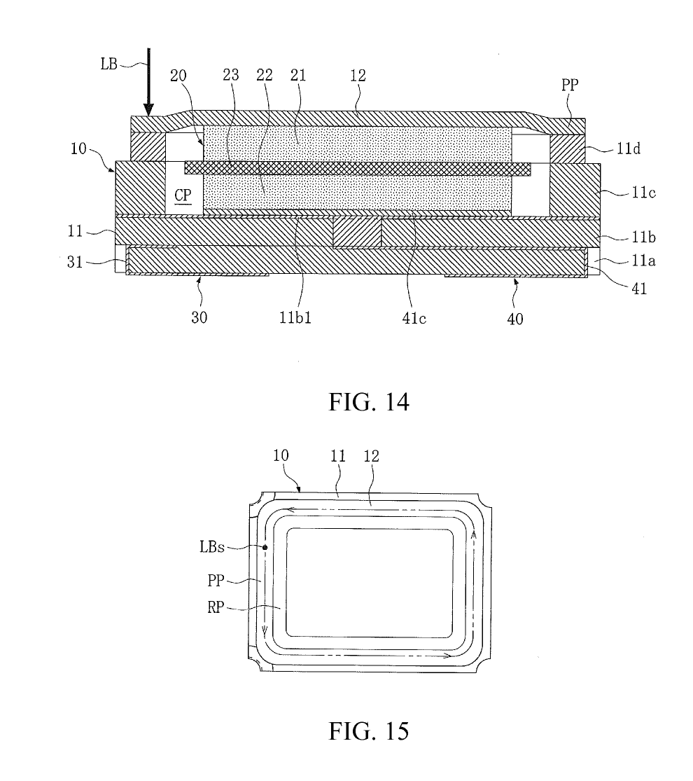

Next, as shown in FIG. 14, the conductive lid 12 is placed on the rigid case 11 such that the bottom face of the welded part PP overlaps with the top face of the welded frame member 11d. In one embodiment, the conductive lid 12 is placed on the rigid case 11 such that the size of a gap between the bottom face of the welded part PP and the top face of the welded frame member 11d is 20 μm or less. Since the size of the gap is 20 μm or less, transmission of irradiation energy from the welded part PP to the welded frame member 11d during irradiation with a laser beam LB described below can be performed without loss. The gap between the bottom face of the welded part PP and the top face of the welded frame member 11d can be adjusted by pressing the conductive lid 12 against the welded frame member 11d using an appropriate jig during irradiation with the laser beam LB described below, performing temporary alignment prior to irradiation with the laser beam LB, or the like.

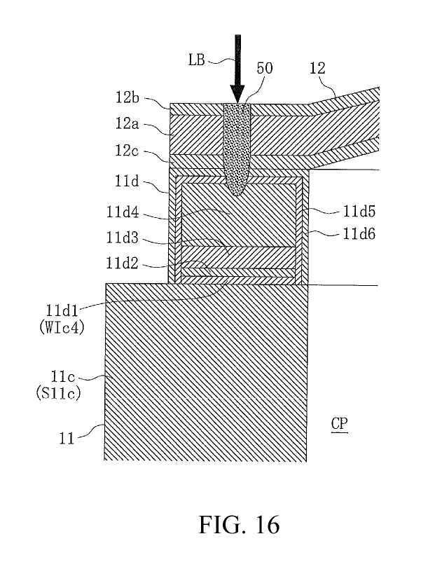

Next, as shown in FIG. 14 and FIG. 15, the top face of the welded part PP of the conductive lid 12 is irradiated with the laser beam LB having a predetermined irradiation diameter LBs. The laser beam LB is applied while moved along the arrow shown in FIG. 15 at a constant speed. In one embodiment, shielding gas (Ar, He or N₂) for antioxidation is sprayed on the irradiated portion during irradiation with laser beam LB.

The laser beam LB is, for example, YAG laser beam. In one embodiment, the top face of the welded part PP of the conductive lid 12 is irradiated with the laser beam LB wherein the beam oscillated by a laser oscillator is transmitted to a condensing lens via an appropriate optical system and the irradiation diameter LBs is adjusted with the condensing lens. In addition, the irradiation diameter LBs of the laser beam LB is smaller than the width Wild (refer to FIG. 8) of the substantially rectangular and framed-shaped welded frame member 11d, and the center of irradiation with the laser beam LB (the center of the irradiation diameter LBs) is substantially identical to the center of the width of the welded frame member 11d (refer to FIG. 15). In the case where the thickness of the conductive lid 12 is 100 μm, the thickness of the Au film 11d6 of the welded frame member 11d is 2 μm and the thickness of the Ni film 11d5 of the welded frame member 11d is 4 μm, desired laser welding can be precisely performed if irradiation energy is 10-50 kW.

As the welded part PP of the conductive lid 12 is irradiated with the laser beam LB, as shown in FIG. 16, irradiation energy of the laser beam LB is transmitted to the Au film 11d6, the Ni film 11d5 and the base member 11d4 of the welded frame member 11d via the Ni layer 12b overlying the welded part PP, the base member 12a and the Ni layer 12c underlying the welded part PP. By the irradiation energy a metal is fused and shaped into a keyhole shape, the fused metal solidifies as time passes, and subsequently a weld bead 50 is formed. The weld bead 50 is formed so as to extend from the welded part PP to the welded frame member 11d and join the welded part PP and the welded frame member 11d in a watertight and airtight manner. Since the laser beam LB is applied while moved along the arrow shown in FIG. 15 at a constant speed, the weld bead 50 is shaped into a ring in a planar view having a predetermined width as shown in FIG. 1A.

In addition, as understood from FIG. 16, since the weld bead 50 is formed such that the width thereof is smaller than the width W11d of the welded frame member 11d (refer to FIG. 8) and the weld bead 50 lies through the substantial center of the width of the welded frame member 11d, the weld bead 50 is not exposed to the internal space (the cavity CP) of the rigid package 10.

As described above, the welded part PP may be welded to the welded frame member 11d by laser welding while temporarily aligning the welded part PP to the welded frame member 11d. This temporary alignment includes techniques such as laser welding performed partially (at several places), spot welding performed at several places, seam welding performed partially (at several places), bonding with an adhesive which disappears during leaser welding, or the like. The temporary alignment is performed for adjustment of a gap between the bottom face of the welded part PP and the top face of the welded frame member 11d, and minimum required force to join the welded part PP and the welded frame member 11d should occur between them. Consequently, in the case of temporary alignment using laser welding, irradiation energy can be set lower than irradiation energy used in forming the weld bead 50. In addition, in the case of temporary alignment using spot welding or seam welding, since applied voltage can be set lower than regular applied voltage, a fused material, coagulum thereof or the like created during spot welding or seam welding for temporary alignment does not enter the internal space of the rigid package 10.

As stated above, in the electrochemical device according to one embodiment of the present invention, the weld bead 50 formed by welding together the welded part PP of the conductive lid 12 and the welded frame member 11d of the rigid case 11 by laser welding, is not exposed to the internal space of the rigid package 10; therefore, the fused material, the coagulum thereof, or the like created during laser welding are prevented from entering into the internal space of the rigid package 10. Accordingly, deterioration of properties due to the material fused by laser welding or the coagulum thereof can be prevented.

In addition, in one embodiment of the present invention, since the width of the weld bead 50 can be as small as 1.0 mm or less, for example, approximately 100 μm by adjusting the irradiation diameter LBs of the laser beam LB, the laser welding can be performed while blocking the fused material or the coagulum thereof from the internal space of the rigid package 10 even if the width Wild of the welded frame member 11d (refer to FIG. 8) is reduced (e.g., 1.0 mm or less) in accordance with downsizing of an electrochemical device.

Further, in one embodiment of the present invention, a face of the welded frame member 11d which faces the internal space of the rigid package 10 is made of Au having corrosion resistance against electrolytic solution, thereby preventing corrosion of the base member 11d4 of the welded frame member 11d which is composed of a Fe—Ni—Co alloy, due to contact of the base member 11d4 and electrolytic solution.

In addition, in one embodiment of the present invention, the conductive lid 12 is made of a cladding material in which a Ni layer 12b and 12c are formed on the top face and the bottom face of the base member (Fe—Ni—Co alloy) 12a; therefore, occurrence of pin holes caused by corrosion of the base member 12a of the conductive lid 12 which is composed of Fe—Ni—Co alloy, due to contact of the base member 12a and electrolytic solution, can be prevented as compared with a case where the Ni layer 12c underlying the base member 12a is formed by plating.

Further, in one embodiment of the present invention, since a Fe-Ni-Co alloy is used as the base member 12a of the conductive lid 12, a coefficient of linear expansion of the conductive lid 12 can be identical to or close to a coefficient of linear expansion of a dielectric portion of a circuit board made of a ceramics composed mainly of Al₂O₃.That is, if the coefficients of linear expansion of the conductive lid 12 and the dielectric portion are substantially the same, the joint between the conductive lid 12 and the dielectric portion is less likely to break, even if thermal expansion and contraction of the conductive lid 12 and the dielectric portion occurs during a process such as reflow soldering to mount the electrochemical device on a surface of a circuit board or the like. Consequently, occurrence of a crack can be prevented.

Embodiments of the present invention are not limited to the embodiments described explicitly in the specification, but the embodiments explained specifically in the specification may be modified in various other ways. For example, the position where the weld bead 50 is formed is not limited to the substantial center of the width of the welded frame member 11d, but may be any position unless the weld bead 50 is exposed to the internal space of the rigid package 10. In addition, other metal films having corrosion resistance against electrolytic solution such as Pt, Ag, Pd, or the like may be used instead of the Au film 11d6.

Further, the Ni layer 12b overlying the conductive lid 12 may be omitted and the conductive lid 12 may be made of the dual-layer cladding material composed of the base member 12a composed of a Fe—Ni—Co alloy and the Ni layer 12c underlying the conductive lid 12. Other metal layers such as Pt, Ag, Au, Pd, or the like can be used instead of the Ni layer 12b and the Ni layer 12c for the conductive lid 12.

The thickness of each of the films composing the welded frame member 11d of the rigid case 11 and the thickness of each of the layers composing the conductive lid 12 explained in the specification are only illustrative, and these illustrative values of thickness are not to be construed as limiting the present invention. The disclosed embodiments can be modified as appropriate in various ways other than the way described explicitly in the specification unless departing from the spirit of the present invention.

### INDUSTRIAL APPLICABILITY

Various embodiments of the present invention may be applied to various electrochemical devices such as electric double layer capacitors, lithium ion capacitors, redox capacitors, and lithium ion batteries.

### LIST OF REFERENCE NUMBERS

10: rigid package, 11: rigid case, CP: cavity of rigid case, 11d: welded frame member of rigid case, 12: conductive lid, PP: welded part of conductive lid, 20: storage element, 21: negative electrode plate, 22: positive electrode plate, 23: separate sheet, 30: negative electrode terminal, 31: first wire, 40: positive electrode terminal, 41: second wire, 50: weld bead.

What claimed is:

1. An electrochemical device comprising:
a rigid package;
a storage element and an electrolytic solution enclosed in an internal space of the rigid package; and
a negative electrode terminal and a positive electrode terminal formed on the bottom face of the rigid package,
wherein the rigid package includes a rigid case having a cavity providing an upward opening and a conductive lid sealing the upward opening of the cavity in a watertight and airtight manner, the rigid case including a first wire for electrically connecting a negative electrode plate of the storage element to the negative electrode terminal via the conductive lid and a second wire for electrically connecting a positive electrode plate of the storage element to the positive electrode terminal;
a welded frame member having a predetermined width is formed integrally on the top of the rigid case so as to surround the cavity; and
a welded part and the welded frame member are joined to each other by laser welding such that a weld bead formed by laser welding at the welded part and the welded frame member is not exposed to the internal space of the rigid package.

2. The electrochemical device of claim 1 wherein the weld bead is formed such that the width thereof is smaller than the width of the welded frame member and the weld bead lies through the substantial center of the width of the welded frame member.

3. The electrochemical device of claim 1 wherein a face of the welded frame member is composed of material having corrosion resistance against the electrolytic solution, the face facing the internal space of the rigid package.

4. The electrochemical device of claim 1 wherein the conductive lid is made of a cladding material having a coefficient of linear expansion substantially identical to a coefficient of linear expansion of the rigid case.

5. The electrochemical device of claim 1 wherein a face of the welded frame member is composed of material having corrosion resistance against the electrolytic solution, the face facing the internal space of the rigid package.

6. The electrochemical device of claim 2 wherein the conductive lid is made of a cladding material having a coefficient of linear expansion substantially identical to a coefficient of linear expansion of the rigid case.

7. The electrochemical device of claim 3 wherein the conductive lid is made of a cladding material having a coefficient of linear expansion substantially identical to a coefficient of linear expansion of the rigid case.
